(19) United States
(12) Patent Application Publication
(10) Pub. No.: US 2026/0032419 A1
(43) Pub. Date: Jan. 29, 2026

(54) HANDOFF CONTROL AMONGST MULTIPLE WIRELESS NETWORKS

(71) Applicant: Charter Communications Operating, LLC, St. Louis, MO (US)

(72) Inventors: Saran Khalid, Denver, CO (US); Perwaiz Akhtar, Aurora, CO (US)

(21) Appl. No.: 18/784,122

(22) Filed: Jul. 25, 2024

(51) Int. Cl. H04W 8/18; H04W 88/06

(52) U.S. Cl. CPC H04W 8/18; H04W 88/06

(57) ABSTRACT

A network environment includes a communication management hardware to manage connectivity of a first mobile communication device to multiple different networks. The communication management resource receives first performance information associated with use of a first mobile communication device in a first geographical region. The first performance information indicates a first performance of wireless connectivity between a first wireless network and the first mobile communication device. The communication management hardware further compares the first performance to a threshold level. Based on the comparing, the communication management hardware produces configuration information to support subsequent handoffs of the first mobile communication device from the first wireless network to a second wireless network based on the first geographical region.

### BACKGROUND

A subscriber identity module or subscriber identification module (SIM), also known a SIM card, is an integrated circuit or electronic file of data that is used to securely store information such as the international mobile subscriber identity (IMSI) telephony number and its related key information. Such information is used to identify and authenticate subscribers and mobile communication devices when they use a respective wireless network.

As previously discussed, a conventional SIM card stores subscriber information such as a unique serial number (ICCID), international mobile subscriber identity (IMSI) number, security authentication and ciphering information, temporary information related to the local network, a list of the services the user has access to, and two passwords such as a personal identification number (PIN) for ordinary use, and a personal unblocking key (PUK) for PIN unlocking.

In certain instances, a mobile communication device can be configured with multiple sets of SIM information. In such an instance, first SIM information enables the mobile communication device to use the first wireless network. Second SIM information enables the mobile communication device to use the second wireless network.

### BRIEF DESCRIPTION OF EXAMPLES

Techniques herein include providing improved wireless connectivity in a network. to support better use of available wireless resources.

For example, a network environment as discussed herein includes a communication management resource to manage connectivity of a first mobile communication device to multiple different networks. The communication management resource receives first performance information associated with use of a first mobile communication device in a first geographical region. The first performance information indicates a first performance of wireless connectivity between a first wireless network and the first mobile communication device. The communication management hardware further compares the first performance to a threshold level. Based on the comparing, and in response to detecting that the first performance is below the threshold level, the communication management hardware produces configuration information to support subsequent handoffs of the first mobile communication device from the first wireless network to a second wireless network during conditions when the mobile communication devices in the first geographical region.

In one example, the first mobile communication device is configured with first SIM (Subscriber Identity Module) information supporting access to the first wireless network; the first mobile communication device is also configured with second SIM (Subscriber Identity Module) information supporting access to the second wireless network. Accordingly, the first mobile communication device is able to connect with both the first wireless network and the second wireless network.

In accordance with still further examples, in furtherance of producing the configuration information as discussed herein, the communication management resource or other suitable entity determines a first geographical region where the first mobile communication device experiences the first performance associated with the wireless connectivity of the first wireless network below the threshold level. The first geographical region may be disposed within a region of wireless coverage associated with the first wireless network. The communication management resource produces the configuration information to support the subsequent handoffs from the first wireless network to the second wireless network in response to conditions in which the first mobile communication device resides within the first geographical region. The communication management resource then implements the configuration information to control the subsequent handoffs of the first mobile communication device from the first wireless network to the second wireless network. In one example, assignment of the configuration information requires the first mobile communication device reside within the geographical region for greater than a threshold amount of time prior to commencing handoff the first mobile communication device from the first wireless network to the second wireless network. Additionally, the configuration information itself may require the first mobile communication device reside within the geographical region for greater than a threshold amount of time prior to commencing handoff the first mobile communication device from the first wireless network to the second wireless network.

Yet further, the first performance as indicated by the first performance information may be based on operation of the first mobile communication device at a first location within the first geographical region. The location may be an edge of a region of wireless coverage provided by the first wireless network. In such an instance, the communication management resource produces the configuration information to support handoff of the first mobile communication device during conditions in which the first mobile communication device is detected as being present in the geographical region.

The configuration information can be implemented by any suitable resource. For example, the communication management resource can be configured to communicate the configuration information to the first mobile communication device. In such an instance, the first communication device can be configured to use the received configuration information to determine which of multiple wireless networks to connect.

Further examples as discussed herein include the communication management resource transmitting a notification to the first mobile communication device. The notification may notify the first mobile communication device to monitor availability of the second wireless network while the first mobile communication device is at the first location or in the first geographical region. In response to transmitting the notification, the communication management resource receives availability information (such as link information) from the first mobile communication device. The availability information indicates an ability of the first mobile communication device to connect to the second wireless network. The communication management resource then produces the configuration information based at least in part on the availability information.

In accordance with still further examples, the communication management resource can be configured to communicate the configuration information (such as handoff configuration information) from the first wireless network to the first mobile communication device.

In another example, the communication management resource produces the configuration information based at least in part on a dwell time of the first mobile communication device residing in the first geographical region or a time of the first mobile communication device using the first wireless network while in the corresponding first wireless network. As previously discussed, the first geographical region may reside in a first region of wireless coverage supported by both the first wireless network and a second region of wireless coverage supported by the second wireless network.

Further, the first performance information may be associated with operation of the first mobile communication device at a first location within the first geographical region. In such an instance, the communication management resource produces the configuration information to support the subsequent handoffs during conditions in which the first mobile communication device resides in the geographical region or at the first location. The geographical region may be a less than all portion of a region of wireless coverage provided by the first wireless network where one or more mobile communication devices have difficulty communicating with one or more wireless base stations in the first wireless network.

Note that the communication management resource may receive performance information associated with multiple different mobile communication devices operated in the network environment. In one example, the communication management resource receives second performance information indicating a second performance of conveying communications between the first mobile communication device and the second wireless network. The communication management resource produces the configuration information based on the second performance information.

Examples herein are useful over conventional techniques. For example, implementation of the configuration information as discussed herein causes a respective mobile communication device to connect to the second wireless network during conditions in which the mobile communication device is present in a geographical region where wireless connectivity to the first wireless network provides only poor wireless service performance to the mobile communication device such as performance below the threshold level.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon. The instructions, when executed by the computer processor hardware, cause the computer processor hardware (such as one or more co-located or disparately processor devices or hardware) to: receive first performance information associated with use of a first mobile communication device in a first geographical region, the first performance information indicating a first performance of wireless connectivity between a first wireless network and the first mobile communication device; compare the first performance to a threshold level; and based on the comparing, produce configuration information to support subsequent handoffs of the first mobile communication device from the first wireless network to a second wireless network based on the first geographical region.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating implementation of multiple wireless networks in a network environment and handoff connectivity control according to examples as discussed herein.

FIG. 2 is an example diagram illustrating overlapping coverage associated with multiple wireless networks and different locations in a network environment where a first wireless network is unable to reliably provide wireless connectivity to communication devices as discussed herein.

FIG. 3 is an example diagram illustrating a history of collected information such as dropped communication links, corresponding dwell time, etc., associated with mobile communication devices in a geographical region as discussed herein.

FIG. 4 is an example diagram illustrating generation of different zones (geographical regions) and generation of corresponding configuration information supporting handoffs from the first wireless network to the second wireless network as discussed herein.

FIG. 5 is an example diagram illustrating generation of handoff configuration information as discussed herein.

FIG. 6 is an example diagram illustrating distribution and implementation of handoff configuration information as described herein.

FIG. 7 is an example diagram illustrating details of a network as discussed herein.

FIG. 8 is a timing diagram illustrating exchange of communications and implementation of handoff control communications as discussed herein.

FIG. 9 is an example diagram illustrating assignment of configuration information supporting handoffs based on a dwell time of a corresponding communication device in a geographical region as discussed herein.

FIG. 10 is an example diagram illustrating assignment of configuration information supporting handoffs based on a dwell time of a corresponding communication device in a geographical region as discussed herein.

FIG. 11 is an example diagram illustrating example computer hardware and software operable to execute operations according to examples herein.

FIG. 12 is an example diagram illustrating a method according to examples herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

A network environment as discussed herein includes a communication management resource to manage connectivity of a first mobile communication device to multiple different networks. For example, the communication management resource receives first performance information associated with use of a first mobile communication device (and potentially other communication devices operated) in a first geographical region. The first performance information indicates a first performance of wireless connectivity between the first mobile communication device and a first wireless network (and potentially connectivity with other communication devices). The communication management resource further compares the first performance to a threshold level. Based on the comparing, and in response to detecting that the first performance is below the threshold level, the communication management hardware produces configuration information to support subsequent handoffs of the first mobile communication device from the first wireless network to a second wireless network. In one example, the configuration information is used as a basis to handoff the first mobile communication device from the first wireless network to the second wireless network when it is detected that the first mobile communication device is present in the first geographical region. In other words, the handoff configuration information based on dwell time can be implemented to force a handoff of the first mobile communication device from a first wireless network to a second wireless network when it is known that the first wireless network does not provide good wireless connectivity to the first mobile communication device.

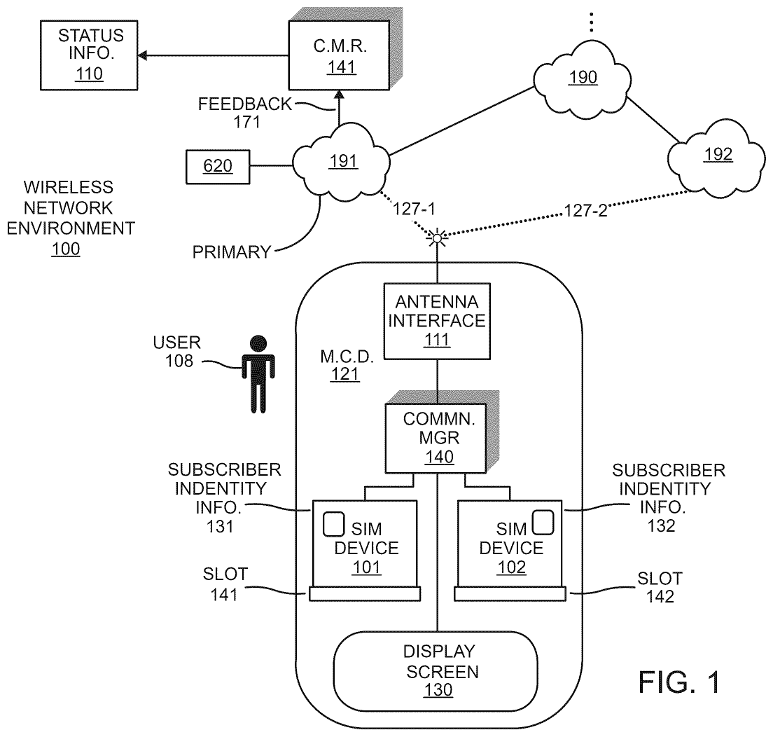

Now, with reference to the drawings, FIG. 1 is an example diagram illustrating implementation of multiple wireless networks in a network environment and connectivity control according to examples as discussed herein.

As shown in this example, the wireless network environment 100 includes communication management resource 141, mobile communication device 121, network 190, network 191, and network 192. Note that the network environment 100 can include any number of mobile communication devices similar to mobile communication device 121.

Further in this example, the mobile communication device 121 is operated by the user 108 and includes antenna interface 111, communication manager 140, SIM device 101, SIM device 102, and display screen 130.

Note that each of the different components (such as communication manager 140, communication management resource 141, etc.) in network environment 100 can be implemented via hardware, software, or a combination of both hardware and software. More specifically, communication manager 140 can be configured as communication manager hardware, communication manager software, or a combination of communication manager hardware and communication manager software; communication management resource 141 can be configured as communication management hardware, communication management software, or a combination of communication management hardware and communication management software; and so on.

In this example, SIM device 101 and corresponding subscriber identity information 131 is inserted in slot 141 or implemented as an electronic SIM (eSIM); SIM device 102 is inserted in slot 142 and corresponding subscriber identity information 132 or implemented as an electronic SIM (eSIM).

Subscriber identity information 131 supports wireless connectivity of the mobile communication device 121 with the first wireless network 191; subscriber identity information 132 supports wireless connectivity of the mobile communication device 121 with the second wireless network 192. Accordingly, the mobile communication device 121 is a dual SIM device.

As further shown, user 108 operates corresponding mobile communication device 121 such as user equipment.

Yet further as discussed herein, using the first subscriber identity information 131, the mobile communication device 121 communicates over the wireless communication link 127-1 through the wireless network 191 to the remote network 190. Using the subscriber identity information 132, the mobile communication device 121 communicates over the wireless communication link 127-2 through the wireless network 192 to the remote network 190.

In one example, the mobile communication device 121 is configured to use the subscriber identity information 131 and corresponding wireless network 191 as a primary means in which to access the network 190 and corresponding destination communication devices or servers. If the wireless network 191 is unavailable, the mobile communication device 121 can be configured to use the network 192 as a way to access the network 190.

Accordingly, the mobile communication device 131 can be configured to switch between establishing the wireless communication link 127-1 and establishing the wireless communication link 127-2 depending upon availability of the wireless network 191. For example, the mobile communication device 121 may be assigned the wireless network 191 as a primary wireless network. In such an instance, the mobile communication device 121 first tries to establish wireless communication link 127-1 with the wireless network 191 to access the remote network 190. If for some reason the mobile communication device 121 is unable to establish the wireless communication link with the wireless network 191, the mobile communication device 122 establishes the wireless communication link 127-2 to access the remote network 190 through the wireless network 192.

As further shown in FIG. 1, the mobile communication device 121 and/or the monitor resource 620 (such as OSS) disposed in the network environment 100 can be configured to monitor the network environment 100 and communicate feedback 171 to the communication management resource 141 based upon the performance associated with the wireless communication link 127-1 and the wireless communication link 127-2. In such an instance, the communication management resource 141 receives feedback 171 such as performance information associated with the mobile communication device 121 accessing the respective remote network 190 through the wireless network 191 and the wireless network 192.

The performance information (feedback 171) may indicate any suitable information indicating performance of the wireless network 191 and the wireless network 192 such as number of dropped calls associated with use of wireless communication link 127-1 and using the wireless network 191 to access the remote network 190, wireless signal strength of receiving communications received by the mobile communication device 121 from the wireless network 191, wireless signal strength of the mobile communication device 121 receiving wireless communications from the wireless network 192, etc.

As further discussed herein, each of the mobile communication devices and monitor resource 620 in the network environment 100 can be configured to provide feedback 171 based on operation of the respective mobile communication device at different locations in the network environment 100. Thus, the performance information (feedback 171) may indicate performance associated with the wireless communication link 127-1 providing the corresponding mobile communication device 121 access to the wireless network 191 and the remote network 190. Additionally, the performance information (feedback 171) may indicate performance associated with wireless communication link 127-2 providing the corresponding mobile communication device 121 access to the wireless network 192 to the remote network 190.

In other examples, based upon the received feedback 171 from one or more communication devices, the communication management resource 141 produces and stores the status information 110 indicating a performance of the first wireless network 191 and the second wireless network 192 providing the different communication devices access to the remote network 190.

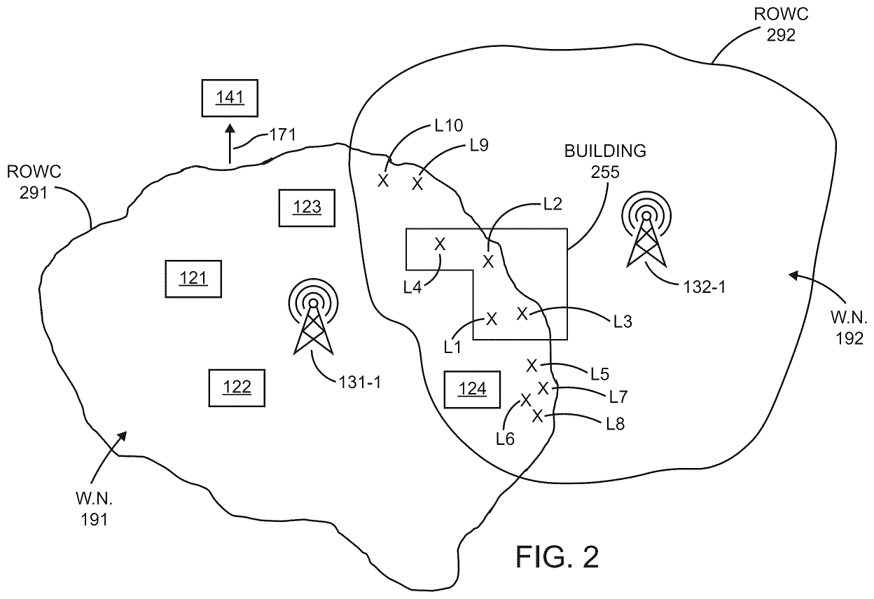

FIG. 2 is an example diagram illustrating overlapping coverage associated with multiple wireless networks and different locations in the network environment where the first wireless network is unable to reliably provide wireless connectivity to communication devices as discussed herein.

In this example of FIG. 2, a UE may be in a low mobility/stationary condition in a building 255. This would be equivalent to UE's in buildings such as customers at homes and offices where they are not mobile.

In this example, each of multiple mobile communication devices 121, 122, 123, etc., roams about the wireless network environment 100. Each of the mobile communication devices 121, 122, 123, etc., is a subscriber to a first wireless network service provider providing the wireless services and wireless network 191 (primary wireless network). The second wireless network 192 is operated by a second service provider as a backup to the wireless network 191. In other words, each of the dual SIM communication devices are able to access remote network 190 via the wireless network 192 if the wireless network 191 is unavailable. However, it is desirable that the mobile communication device 121 and other communication devices use the wireless network 191 to access the network 190 if the wireless network 191 is available.

Thus, the mobile communication device 121 is configured to first establish wireless connectivity with the wireless network 191 to access the remote network 190. If the mobile communication device 121 is unable to establish a wireless communication link 127-1 with the wireless network 191, the mobile communication device 121 is configured to alternatively establish a wireless communication link 127-2 with the wireless network 192 in order to access the network 190.

Each of the mobile communication devices 122, 123, etc., is configured in a similar manner.

As previously discussed, as each of the communication devices roam around the wireless network environment 100, the monitor resource 620 and the communication devices provide corresponding feedback 171 to the communication management resource 141. The communication devices are operated at different locations in the network environment 100 to access the remote network 190 through either the wireless network 191 or the wireless network 192. At each of the locations where the mobile communication devices are used, the mobile communication devices in monitor resource 620 provide feedback 171.

In one example, the locations L1, L2, L3, L4, L5, L6, L7, L8, L9, L10, etc., are all located on an edge of the region of wireless coverage 291 associated with the wireless network 191. These are regions far away from the wireless base station 131-1, which may result in one or more of the communication devices being unable to communicate with the wireless base station 131-1.

In one example, via the feedback 171, the communication management resource 141 monitors parameters such as a respective location where the respective communication device experiences the inability (such as dropped calls for communication links) to access the network 190 through the first wireless network as well as a corresponding time (dwell time) during which the operator and corresponding communication device are present at the respective location.

Additionally, via the feedback 171, the communication management resource 141 can be configured to monitor one or more parameters such as a time of day that the communication device is present at the respective location, the duration of time that the mobile communication device and corresponding operator reside at the respective location, the duration of time that the mobile communication device and corresponding operator use the wireless network 191 to access the remote network, the number of dropped communication links associated with the mobile communication device attempting to use the wireless network 191 at a particular location or geographical region, link quality information (such as based on path loss) associated with each of the wireless networks, etc.

An example of the communication management resource 141 receiving feedback 171 from the different mobile communication devices 121, 122 123, etc., is shown in FIG. 2. In one example, for each instance of a respective wireless communication link being terminated due to poor link quality between the respective mobile communication device and the first wireless network such as wireless base station 131-1, the communication management resource 141 produces the status information to keep track of: i) a location of the respective mobile communication device, ii) a time in which a respective mobile communication device is at the particular location, iii) how many times a respective wireless communication link is dropped during the dwell time.

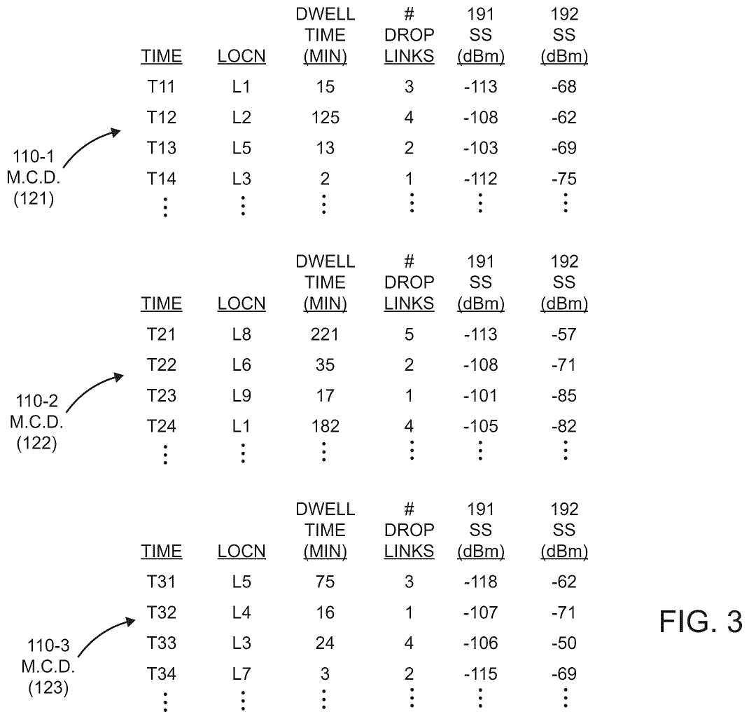

An example of the status information 110 associated with the mobile communication devices is shown in FIG. 3.

FIG. 3 is an example diagram illustrating a history of dropped communication links and corresponding dwell time associated with mobile communication devices in a geographical region as discussed herein.

In this example, the communication management resource 141 produces and stores the status information for each of the mobile communication devices monitored in the network environment 100.

For example, the communication management resource 141 produces status information 110-1 based on feedback 171 received from the mobile communication device 121 and/or monitor resource 620; the communication management resource 141 produces status information 110-2 based on feedback 171 received from the mobile communication device 122 and/or monitor resource 620; the communication management resource 140 produces status information 110-3 based on feedback 171 received from the mobile indication device 123 and/or monitor resource 620; and so on.

More specifically, in this example, the communication management resource 141 receives feedback 171 indicating presence of the mobile communication device 121 at location L1 at or around time T11 for a duration of 15 minutes during which the mobile communication device 121 experiences 3 terminated communication sessions (dropped links requiring reestablishment of a respective wireless communication link) with the wireless network 191 based upon poor wireless link quality (wireless signals transmitted by the wireless network 191 are received by the mobile communication device 121 at a power level of −113 dBm, wireless signals transmitted by the wireless network 192 are received by the mobile communication device 121 at a power level of −68 dBm); the communication management resource 141 receives feedback 171 indicating presence of the mobile communication device 121 at location L2 at or around time T12 for a duration of 125 minutes during which the mobile communication device 121 experiences 4 terminated communication sessions with the wireless network 191 based upon poor wireless link quality (wireless signals transmitted by the wireless network 191 are received by the mobile communication device 121 at a power level of −108 dBm, wireless signals transmitted by the wireless network 192 are received by the mobile communication device 121 at a power level of −62 dBm); the communication management resource 141 receives feedback 171 indicating presence of the mobile communication device 121 at location L5 at or around time T13 for a duration of 13 minutes during which the mobile communication device 121 experiences 2 terminated communication session with the wireless network 191 based upon poor wireless link quality when connected to the wireless network 191 (wireless signals transmitted by the wireless network 191 are received by the mobile communication device 121 at a power level of −103 dBm, wireless signals transmitted by the wireless network 192 are received by the mobile communication device 121 at a power level of −69 dBm); the communication management resource 141 receives feedback 171 indicating presence of the mobile communication device 121 at location L3 at or around time T14 for a duration of 2 minutes during which the mobile communication device 121 experiences 1 terminated communication session with the wireless network 191 based upon poor wireless link quality when connected to the wireless network 191 (wireless signals transmitted by the wireless network 191 are received by the mobile communication device 121 at a power level of −112 dBm, wireless signals transmitted by the wireless network 192 are received by the mobile communication device 121 at a power level of −75 dBm); and so on.

Based on the received feedback 171 from the communication device 121 roaming around the network environment 100, the communication management resource 141 produces the status information 110-1 associated with the mobile communication device 121.

Further in this example, the communication management resource 141 receives feedback 171 indicating presence of the mobile communication device 122 at location L8 at or around time T21 for a duration of 221 minutes during which the mobile communication device 122 experiences 5 terminated communication sessions with the wireless network 191 based upon poor wireless link quality when connected to the wireless network 191 (wireless signals transmitted by the wireless network 191 are received by the mobile communication device 121 at a power level of −113 dBm, wireless signals transmitted by the wireless network 192 are received by the mobile communication device 121 at a power level of −57 dBm); the communication management resource 141 receives feedback 171 indicating presence of the mobile communication 122 at location L6 at or around time T22 for a duration of 35 minutes during which the mobile communication device 122 experiences 2 terminated communication sessions with the wireless network 191 based upon poor wireless link quality when connected to the wireless network 191 (wireless signals transmitted by the wireless network 191 are received by the mobile communication device 121 at a power level of −108 dBm, wireless signals transmitted by the wireless network 192 are received by the mobile communication device 121 at a power level of −71 dBm); the communication management resource 141 receives feedback 171 indicating presence of the mobile communication device 122 at location L9 at or around time T23 for a duration of 17 minutes during which the mobile communication device 122 experiences 1 terminated communication session with the wireless network 191 based upon poor wireless link quality when connected to the wireless network 191 (wireless signals transmitted by the wireless network 191 are received by the mobile communication device 121 at a power level of −101 dBm, wireless signals transmitted by the wireless network 192 are received by the mobile communication device 121 at a power level of −85 dBm); the communication management resource 141 receives feedback 171 indicating presence of the mobile communication device 122 at location L1 at or around time T24 for a duration of 182 minutes during which the mobile communication device 122 experiences 4 terminated communication session with the wireless network 191 based upon poor wireless link quality when connected to the wireless network 191 (wireless signals transmitted by the wireless network 191 are received by the mobile communication device 121 at a power level of −105 dBm, wireless signals transmitted by the wireless network 192 are received by the mobile communication device 121 at a power level of −82 dBm); and so on.

Based on the received feedback 171 from the communication device 122 roaming around the network environment 100, the communication management resource 141 produces the status information 110-2 associated with the mobile communication device 122.

Yet further in this example, the communication management resource 141 receives feedback 171 indicating presence of the mobile communication device 123 at location L5 at or around time T31 for a duration of 75 minutes during which the mobile communication device 123 experiences 3 terminated communication sessions with the wireless network 191 based upon poor wireless link quality when connected to the wireless network 191 (wireless signals transmitted by the wireless network 191 are received by the mobile communication device 121 at a power level of −118 dBm, wireless signals transmitted by the wireless network 192 are received by the mobile communication device 121 at a power level of −62 dBm); the communication management resource 141 receives feedback 171 indicating presence of the mobile communication 123 at location LA at or around time T32 for a duration of 16 minutes during which the mobile communication device 122 experiences 1 terminated communication session with the wireless network 191 based upon poor wireless link quality when connected to the wireless network 191 (wireless signals transmitted by the wireless network 191 are received by the mobile communication device 121 at a power level of −107 dBm, wireless signals transmitted by the wireless network 192 are received by the mobile communication device 121 at a power level of −71 dBm); the communication management resource 141 receives feedback 171 indicating presence of the mobile communication device 123 at location L3 at or around time T33 for a duration of 24 minutes during which the mobile communication device 123 experiences 4 terminated communication session with the wireless network 191 based upon poor wireless link quality when connected to the wireless network 191 (wireless signals transmitted by the wireless network 191 are received by the mobile communication device 121 at a power level of −106 dBm, wireless signals transmitted by the wireless network 192 are received by the mobile communication device 121 at a power level of −58 dBm); the communication management resource 141 receives feedback 171 indicating presence of the mobile communication device 123 at location L7 at or around time T34 for a duration of 3 minutes during which the mobile communication device 122 experiences 2 terminated communication session with the wireless network 191 based upon poor wireless link quality when connected to the wireless network 191 (wireless signals transmitted by the wireless network 191 are received by the mobile communication device 121 at a power level of −115 dBm, wireless signals transmitted by the wireless network 192 are received by the mobile communication device 121 at a power level of −69 dBm); and so on.

Based on the received feedback 171 from the communication device 123 roaming around the network environment 100, the communication management resource 141 produces the status information 110-3 associated with the mobile communication device 123.

In this manner, the communication management resource 141 produces a respective status information (a.k.a., performance information) associated with each of the mobile communication devices operating in the network by 100 experience a respective one or more link drop.

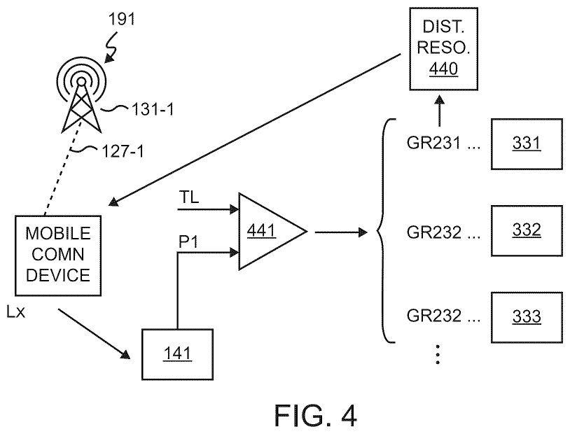

FIG. 4 is an example diagram illustrating generation of handoff configuration information as discussed herein.

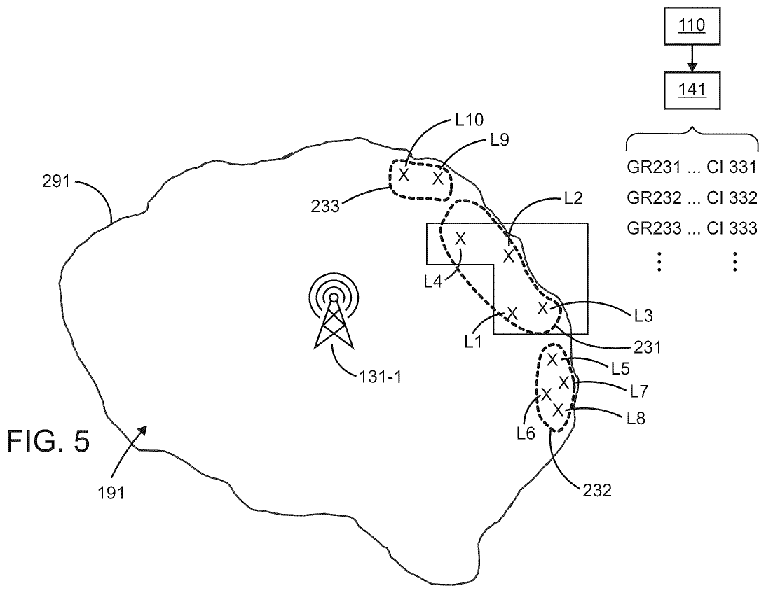

As further discussed herein, the communication management resource can be configured to receive first performance information (such as status information 110-1) associated with use of a first mobile communication device in a first geographical region (231 of FIG. 5). The status information 110-1 such as first performance information indicates a first performance P1 of wireless connectivity between the first mobile communication device and a first wireless network 191.

In one example, the communication management resource 141 implements a corresponding comparator function 441 to analyze a performance value such as P1 associated with the status information 110-1. The performance value P1 can be derived in any suitable manner from the status information 110-1 such as based on one or more of: the time in which the mobile communication device 121 is present at a corresponding location, the number of dropped communication links all at that location, a respective signal strength of wirelessly receiving signals from the first wireless network, and so on.

Note further that the performance value P1 may be derived based on a weighting of multiple different parameters as indicated by the feedback 171 and corresponding status information 110-1. It is desirable that the performance associated with the first wireless network 191 providing wireless service to the mobile communication devices is above a threshold level for all geographical regions and locations that reside within the region of wireless coverage 291 provided by the wireless network 191.

In furtherance of providing good wireless service to the mobile communication devices 121, 122, 123, etc., that subscribe to services provided by the wireless network 191, the comparator function 441 compares the performance level P1 (representing performance of the mobile communication device communicating with the first wireless network 191) with a respective threshold level. The threshold level can be generated in any suitable manner. In one example, the threshold level TL is chosen such that any performance greater than the threshold level provides good wireless service to any of the mobile communication devices that subscribe to use of the wireless network 191. Anything below the threshold level TL means that the wireless network 191 provides poor wireless service to those mobile communication devices.

Based on comparison of the performance P1 associated with the mobile communication device 121 (or even multiple mobile communication devices operating in the network environment 100) to the threshold level TL, the communication management resource 141 selectively generates corresponding handoff configuration information. For example, if the mobile communication device experiences poor service in a particular location or geographical region as indicated by the performance T1 is below the threshold level TL as indicated by the comparator function 441, the communication management resource 141 generates a respective handoff configuration information to control handoff the respective mobile communication device from the first wireless network 191 to the second wireless network 192 in response to detecting subsequent conditions in which the mobile communication device is present at a particular location or geographical region where the wireless network 191 provides poor service below the threshold level TL.

Accordingly, examples herein include the communication management resource 141 or other suitable entity producing respective configuration information in response to detecting that the first performance of the communication link between the mobile communication device and the first wireless network 191 is below the threshold level.

Note further that the handoff configuration information can be generated for a corresponding geographical region if desired. In such an instance, the communication management resource 141 produces the handoff configuration information associated with a respective first geographical region such that the generated handoff information supports handoffs of the first mobile communication device from the first wireless network 191 to the second wireless network 192 when the mobile communication device is present in the first geographical region.

Yet further, generation of the handoff configuration information by the communication management resource 141 may include the communication management resource 141 determining a respective geographical region where the first mobile communication device (and/or other mobile communication devices) experience a wireless service performance provided by the wireless network 191 performance below the threshold level.

Note that the respective geographical regions (such as geographical region 231, geographical region 232, geographical region 233, etc.) may be disposed within a region of wireless coverage 291 associated with the first wireless network 191. In other words, the region of wireless coverage 291 indicates that the wireless network 191 and corresponding wireless base stations such as including wireless base station 131-1 generally can provide wireless service to any mobile communication devices within the region of wireless coverage 291. However, the level of service provided at the edge of the region of wireless coverage 291 may change over time, resulting in poor wireless service or many dropped wireless communication links with corresponding mobile communication devices. Thus, even though the wireless network 191 and provide sufficient wireless power level to communication devices on the edge of the region of wireless coverage 291 at certain times, the communication management resource 141 can be configured to produce the configuration information to support the subsequent handoffs from the first wireless network 191 and the second wireless network 192 in response to conditions in which the first mobile communication device resides within a respective geographical region.

In one example, after analyzing the status information 110 from each of the mobile communication devices in monitor resource 620 providing corresponding feedback 171, the communication management resource 141 produces the handoff configuration information 331 for the geographical region 231; the communication management resource 141 produces the handoff configuration information 332 for the geographical region 232; the communication management resource 141 produces the handoff configuration information 333 for the geographical region 233; and so on.

In one example, the network environment includes the handoff configuration information distribution function 440 to distribute the corresponding handoff configuration information (331, 332, 333, etc.) depending upon one or more parameters such as whether the corresponding mobile communication device operates in a particular geographical region, an amount of time that the mobile communication device resides within the particular geographical region, the number of dropped communication links experience by the communication device in the corresponding geographical region, etc.

It is noted that not every communication device operated in a particular geographical region will experience poor wireless connectivity with the wireless network 191. In such an instance, the communication management resource 141 can be configured to determine which group of devices operate in a particular geographical region experience a poor performance and configure those devices to implement the handoff configuration information when a corresponding device in the group is present in the particular region. Other communication devices in the geographical region that do not experience the corresponding poor connectivity with the wireless network 191 are not configured to perform a respective handoff from the first wireless network 191 to the second wireless network 192 because it is not needed.

As further discussed herein, on an as needed basis, the communication management resource 141 or other suitable entity such as the distribution resource 440 can be configured to distribute the handoff configuration information associated with each of the geographical regions 231, 232, 233, etc.

Thus, examples herein include the communication management resource 141 or other suitable entity implementing the configuration information to control the subsequent handoffs of the first mobile communication device from the first wireless network to the second wireless network. The configuration information communicated to the mobile communication devices may require the respective mobile communication device to reside within a respective geographical region for greater than a threshold amount of time prior to commencing handoff the first mobile communication device from the first wireless network to the second wireless network.

Additional details of determining how to distribute the handoff configuration information as further discussed below.

FIG. 5 is an example diagram illustrating generation of different zones (geographical regions) and corresponding configuration information supporting handoff from the first wireless network to the second wireless network as discussed herein.

In this example, based on the analysis of status information 110, the communication management resource 141 determines different geographical regions where one or more mobile communication device experience sufficiently poor wireless link quality with the wireless network 191 such as those conditions resulting in respective one or more dropped communication sessions or links. The dropped communication sessions may require the respective mobile communication device to dial a respective phone number again to establish connectivity with a respective remote communication device through a wireless network 191.

More specifically, in one example, the communication management resource 141 determines different geographical regions based on clustering of locations (locations that are within a threshold distance of each other, dead spot locations which are locations where service provided by the network 191 is occasionally good and occasionally bad) where the wireless network 191 provides only poor wireless service to respective mobile communication devices even though they are within the region of wireless coverage 291.

In this example, the communication management resource 141 determines that the combination of locations L1, L2, L3, and L4, are within a threshold distance of each other and therefore represent a first geographical region 231 where one or more mobile communication devices routinely experience poor wireless link quality when trying to connect to the first wireless network 191. The communication management resource 141 produces a respective geographical region such that includes the corresponding cluster of (dead spot) locations. The feedback 171 include information indicating a wireless signal level at which the communication devices in the geographical region 231 receives wireless signals from the wireless base station 131-1 and the wireless base station 132-1.

In this example, assume that the feedback 171 indicates that the communication devices in the geographical region 231 collectively are only able to receive a wireless signal from the wireless base station 131-1 and corresponding wireless network 191 at a power level of less than −100 dBm or other suitable value corresponding to poor wireless service. Further, via the feedback 171, the communication management resource 141 determines that communication devices at the locations L1, L2, L3, and L4, all experience good wireless connectivity with the wireless base station 132-1 in the wireless network 192. For example, assume that the communication management resource 140 detects no dropped communication sessions and/or the communication devices from network 192 in the geographical region 231 and/or that the communication devices in the geographical region 231 are able to receive wireless signals from the wireless base station 132-1 and corresponding wireless network 192 greater than −90 dBm. In such an instance, the communication management resource 140 produces the handoff configuration information 110-1 associated with the geographical region 231. The handoff configuration information 110-1 may include settings to handoff a respective mobile communication device from the first wireless network 191 to the second wireless network 192 during conditions in which the respective mobile communication device is present in the geographical region 231 as specified by the configuration information 331-1.

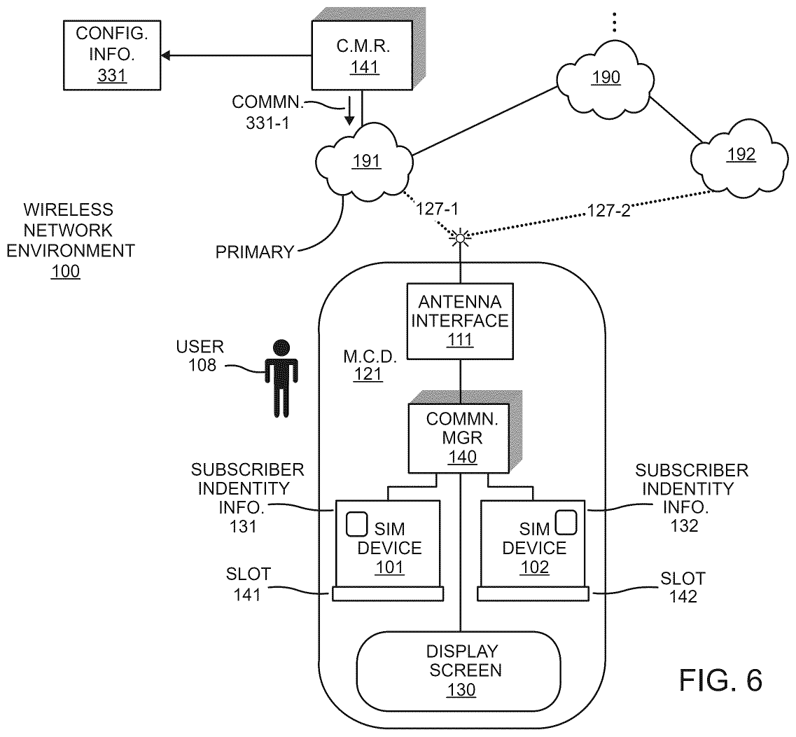

FIG. 6 is an example diagram illustrating implementation of handoff configuration information as described herein.

As previously discussed, the communication management resource 141 can be configured to analyze the received feedback 171 to produce the corresponding status information 110-1 associated with the use of mobile communication device 121 in the network environment 100. Via the feedback, the communication management resource 141 detects that the mobile communication device 121 is operated at multiple locations including location L1, location L2, location L3, etc., at different times.

In one example, in response to detecting operation of the mobile communication device 121 in the geographical region 231 (or one or more specific locations L1, L2, L3, L4, . . . ) and potentially poor wireless service (such as due to dropped links, dropped data packets, low data rate, etc.) provided by the wireless network 191 to the mobile communication device 121, the communication management resource 141 assigns the handoff configuration information 331 associated with the geographical region 231 to the mobile communication device 121. In such an instance, the communication management resource 141 or other suitable entity transmits communications 331-1 including the handoff configuration information 331 over the wireless network water 91 to the mobile communication device 121.

The recipient mobile communication device 121 (locally or remotely) stores the configuration information 331 and then uses the configuration information 331 to determine when to handoff from the first wireless network 191 to the second wireless network 192.

It is further noted that another mobile communication device such as mobile communication device 124 may operate at the same locations as the mobile communication device 121. However, the wireless network 191 may provide good service to the mobile communication device 124 while the mobile communication devices in the geographical region 231. In such an instance, based on feedback 171 from the mobile communication device 124 and monitor resource 620 indicating good wireless service provided by the wireless network 191 to the mobile communication device 124 while the mobile communication device 124 is in the geographical 231, there is no need for the communication management resource 141 to communicate the handoff configuration information 331 to the mobile communication device 124 because it is preferred that the mobile communication device (a subscriber of the first wireless network 191) use the first wireless network 191 instead of the second wireless network 192 when the first wireless network is available.

Note that the configuration information 331 can be configured to indicate the boundaries (such as meets and bounds, border, regions, etc.) associated with the geographical region 231 to which the corresponding handoff configuration information 331 applies. Because the mobile communication device 121 has been assigned use of the handoff configuration information 331, when the mobile communication device 141 detects that it resides within the geographical region 231, the mobile communication device 121 and corresponding communication manager 140 use the handoff configuration information 331 to determine when the mobile communication device 121 is to connect to or handoff to the second wireless network 192 for access to the remote network 190. Accordingly, the handoff configuration information 331 provides an offloading mechanism to switch over to the use of the second wireless network 192 instead of the first wireless network 191 during conditions in which the mobile communication device 121 is in the geographical region 231.

As previously discussed, the communication management resource 141 can be configured to further produce the configuration information 331 contingent upon detecting that the second wireless network 192 is able to provide good wireless service to the mobile communication devices while they are present in the geographical region 231. In other words, there is no need to handoff a respective mobile communication device to the second wireless network 192 if it does not provide good wireless service to the mobile communication device. Recall that the communication management resource 141 is aware that the wireless network 192 provides good wireless connectivity based on signal strength of one or more respective wireless signals transmitted by the wireless base station 132-1 to the mobile communication devices in the geographical region 231. Thus, based on feedback from the one or more mobile communication devices and/or the monitor resource 620 operated in the network environment 100 and corresponding geographical region 231, the communication management resource 141 is aware that the second wireless network 192 provides good wireless service above a threshold level to any mobile communication devices in the geographical region 231.

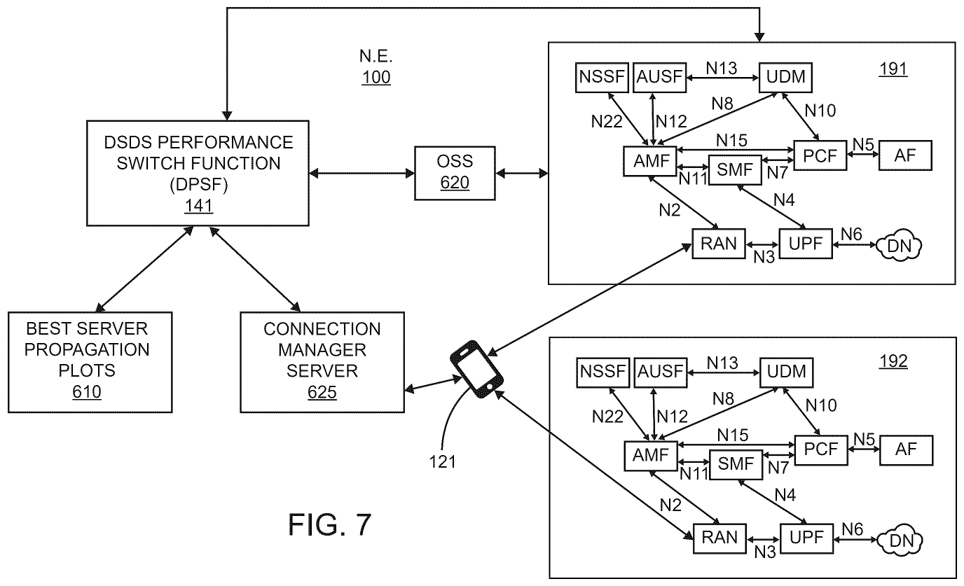

FIG. 7 is an example diagram illustrating details of the network as discussed herein.

In one example, the communication management resource 141 is implemented as or includes a so-called DSPF (DSDS Performance Switch Function) that is in communication with multiple resources in the network environment 100.

In one example, the first operation implemented by the communication management resource 141 is to obtain KPIs/counter data from the monitor resource 620 (such as OSS or Operational Support Systems) to identify poorly performing cellular regions of wireless coverage where wireless services are provided to corresponding communication devices. This can be achieved by the communication management resource 141 obtaining the data regarding the quality directly from the monitor resource 620 or the communication devices themselves.

The communication management resource 141 then determines if a particular communication device (a.k.a., UE or user equipment) or a set of UE's within the coverage of a cell are causing a large number of drops. This can be done in any suitable manner such as either using the services of collection function or receiving performance data associated with respective communication links directly from the wireless network 191 (core network).

The communication management resource 141 further determines if a significant number, i.e., a higher percentage, of drops/connection failures are associated with a particular mobile communication device. The communication devices experiencing poor network connection to the wireless network 191 are short listed along with their signal and signal quality information. It is noted that if these link drops and corresponding poor wireless service from the wireless network 191 may be consistently happening within the coverage of the same cell as indicated by historical data to confirm the particular region of wireless coverage experiencing the issue.

Further, the next operation is to determine the location of the communication devices when they experience a respective drop associated with a wireless service such as loss of the wireless connection, low data rate, etc. The location of the dropped wireless link is useful to determine the region of wireless coverage (291) and corresponding wireless base station of interest (131-1).

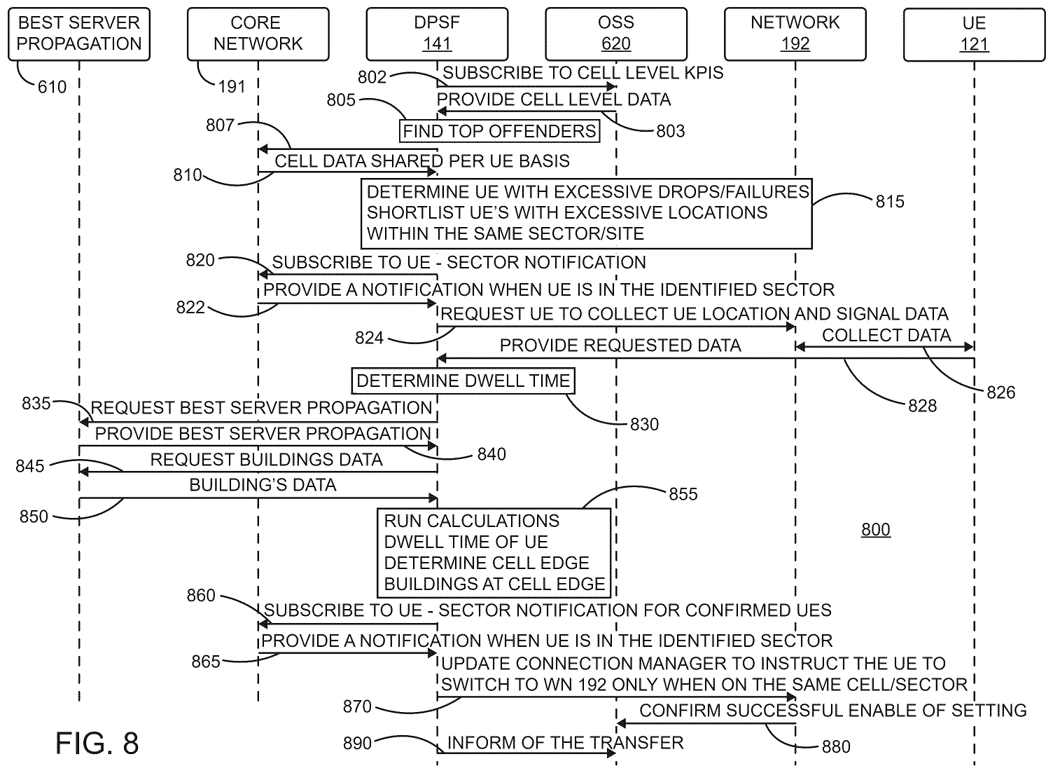

FIG. 8 is a timing diagram illustrating exchange of communications to support handoff control as discussed herein.

In this example, timing diagram 800 illustrates conveyance of communications amongst different resources to implement configuration of communication devices as discussed herein.

Via communications 802, the communication management resource 141 registers with the monitor resource 620 to receive performance information (link quality performance as previously discussed such as feedback 171) associated with operation of the mobile communication devices communicating with the different wireless networks 191 and 192.

The monitor resource 620 produces performance information (such as feedback 171) indicating link quality between each of the mobile communication devices and the networks 191 and 192.

Via communications 803, the monitor resource 620 provides feedback 171 associated with the wireless communication links 127-1 and 127-2 as well as other communication links in the network environment 100. As previously discussed, based on the feedback 171 from communication devices and/or the monitor resource 620, the communication management resource 141 produces the status information 110-1 for the mobile communication device 121, status information 110-2 for the mobile communication device 122, and so on.

In processing operation 805, via the received performance information from the monitor resource 620 or other suitable entity such as mobile communication devices themselves, the communication management resource 140 determines one or more mobile communication devices that experience poor link quality with wireless network 191.

Via communication 807, the communication management resource 141 provides the cell data (mobile communication devices to be monitored) to the wireless network 191. Via communications 810, the communication management resource 140 receives acknowledgment.

In processing operation 815, the communication management resource 141 processes information received from the wireless network 191 and determines which of the mobile communication devices experiences drops/failures associated with communication links above a threshold level. Additionally, in processing operation 815, the communication management resource 141 produces a respective list of mobile communication devices that are present at multiple locations within the same region of wireless coverage 291 supplied by the wireless network 191.

Via communications 820, the communication management resource 141 subscribes to mobile communication device sector notifications.

Via communications 822, the wireless network 191 provides notification when a respective mobile communication device is in an identified sector of interest.

Via communications 824, the communication management resource 141 requests that the mobile communication device 121 collect signal information from the wireless network 192 such as the magnitude of wireless signals received by the mobile communication device 121 from the wireless network 192.

Via communications 826, the mobile communication device 121 monitoring wireless signals from the wireless network 192 determines a respective link quality between the mobile communication device 121 and the wireless network 192 such as wireless base station 132-1.

Via communications 828, the mobile communication device 121 communicates the link quality information associated with the wireless communication link 127-2 to the communication management resource 141.

In processing operation 830, the communication management resource 141 determines a respective dwell time associated with the mobile communication device 121 being present at any of the locations or in geographical regions as discussed herein.

Via communications 835, the communication management resource 141 sends a request to the best server propagation.

Via communications 840, the communication management resource 141 provides the best server propagation server information to the communication management resource 141.

Via communications 845, the communication management resource 141 requests building data from the best server propagation 610.

Via communications 850, the best server propagation 610 provides the building data associated with building 255 to the communication management resource 141.

In processing operation 855, the communication management resource 141 analyzes parameters and/or calculates information such as: dwell time associated with each of the instances of mobile communication device, determines whether the devices on a cell edge, determines buildings at the cell edge, etc.

Via communications 860, the communication management resource 141 subscribes to the mobile communication device sector notification for specified mobile communication devices provided poor wireless service to the wireless network 191. Via communications 865, the wireless network 191 provides notification when the mobile communication device 121 is in a respective identified sector (geographical region providing poor wireless service).

Via communications 870, the communication management resource 141 updates the connection manager associated with the mobile communication device 121 to instruct the mobile communication device 121 to switch to the wireless network 192 when on the same cell sector (geographical region) based on hand off configuration information.

Via communications 880, the wireless network 190 to confirm successful enablement of the use of wireless network 192 to the monitor resource 620.

Via communications 890, the communication management resource 141 provides notification to the monitor resource 620 of the transfer of the mobile communication device 121 to the second wireless network 192.

Note that the data collection of information associated with communication devices with high drop rates or amounts helps to determine if the mobile communication device actually dwells in those location for a longer periods of time at the cell edge.

In order to confirm the cell edge, a few different techniques can be used such as: i) Signal strength of the UE and location, ii) Propagation, signal strength and the location of the UE, iii) manually assign the UE to cell edge issues.

Once it has been determined that the UE (a.k.a., mobile communication device) is present at the cell edge dwelling for long periods of time, every time the UE enters that cell/sector, it will be instructed to move to a different network and dwell on it until its within that area. This may be done over the second wireless network 192.

In one example, the communication management resource can be configured to notify the mobile communication device when it is in a respective geographical region where it should switch over to the wireless network 192. The communication management resource 141 can be configured to notify the mobile communication device to move back to connecting with the first wireless network 191 when the mobile communication devices no longer at the edge of the corresponding region of wireless coverage 291.

In accordance with further examples, the communication management resource or other suitable entity can be configured to transmit a notification to the mobile communication device 121. The notification may instruct the mobile communication device 121 to monitor availability of the second wireless network 192 while the first mobile communication device is at a particular location. In response to transmitting the notification, the communication management resource 141 may receive availability information from the first mobile communication device 121. The availability information may indicate an ability of the first mobile communication device to connect to the second wireless network. The communication management resource 141 then produces the respective handoff configuration information based at least in part on the availability information. In other words, the communication management resource 141 may be configured to check whether the second wireless network 192 is able to provide good wireless connectivity to the mobile communication device 121 prior to producing the handoff configuration information indicating to handoff to the second wireless network 192.

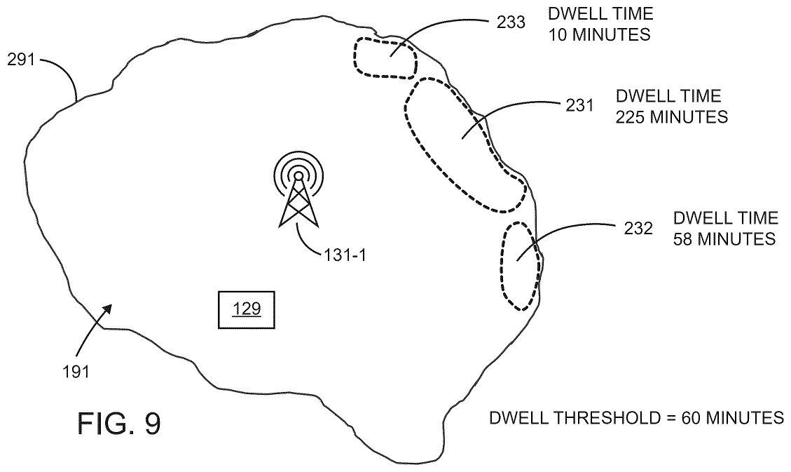

FIG. 9 is an example diagram illustrating assignment of configuration information supporting handoffs based on a dwell time of a corresponding communication device in a geographical region as discussed herein.

As previously discussed, the communication management resource 141 can be configured to produce the handoff configuration information (instructions to handoff) for each of the multiple geographical regions 231, 232, 233, etc., based upon feedback from one or more resources monitoring performance provided by the first wireless network 191 and the second wireless network 192 to the mobile communication devices.

Each set of the handoff configuration information 331, 332, 333, etc., as discussed herein supports handoff from the first wireless network 191 to the second wireless network 192 during conditions in which the respective mobile communication device happens to be in a corresponding geographical region.

It is noted that the geographical region 231 associated with the handoff configuration information 331 is a less than all portion of the region of wireless coverage 291; the geographical region 232 associated with the handoff configuration information 332 is less than all portion of the region of wireless coverage 291; the geographical region 233 associated with the handoff configuration information 333 is a less than all portion of the region of wireless coverage 291; and so on.

In one example, the locations L1, L2, L3, L4, L5, L6, L7, L8, L9, L10, etc., are all located on an edge of the region of wireless coverage 291 associated with the wireless network 191. These are regions far away from the wireless base station 131-1, which may result in one or more of the communication devices being unable to communicate with the wireless base station 131-1.

However, as previously discussed, not every communication device 121, 122, 123, 124, etc., will have difficulty communicating with the wireless base station 131-1 and corresponding wireless network 191 when they are residing at locations L1-L10 because some communication devices will work better than others. Techniques herein may include configuring only those communication devices that experience a respective inability to reliably transmit or receive communications from the wireless base station 131-1 over time.

Also, another factor that may be considered for configuring a respective mobile communication device with corresponding handoff configuration information is the amount of time (a.k.a., dwell time) that the mobile communication device experiencing the unreliability of using wireless network 191 is present in a corresponding location or geographical region.

In other words, there is no need to configure a respective communication device that experiences a poor connection with the wireless network 191 and corresponding wireless base station 131-1 if that communication device is only used for a very short amount of time while at a corresponding edge of the region of wireless coverage 291 such as at locations L1-L10.

Alternatively, if a respective communication device 121 experiences a respective poor connection with the wireless network 191 while at the locations L1-L10 and the communication device is present at the one or more locations or corresponding geographical region for more than a threshold amount of time, then the communication management resource 141 configures that communication device 121 (or other communication devices experiencing similar circumstances) with the appropriate handoff configuration information depending upon where and how long the communication device dwells.

As further shown in this example, assume that the mobile communication device 129 is newly used in the network environment 191. The communication management resource 141 can be configured to monitor feedback 171 received from the communication device 129 in the monitor resource 620 to determine a dwell time in which the mobile communication device 129 is present in each of the geographical region 231, geographical region 232, and geographical region 233.

In this example assume that the communication management resource 141 detects that the communication device 129 is present in the geographical region 231 for 225 minutes; the communication management resource 141 detects that mobile communication device 129 is present in the geographical region 232 for 58 minutes; the communication management resource detects that the mobile communication device 129 is present in the geographical region 233 for 10 minutes.

Additionally, assume that the communication management resource 141 also receives feedback 171 indicating that the mobile communication device 129 experiences a respective poor link quality with the wireless network 191 when the mobile communication devices is in geographical regions 231, 232, 233. In such an instance, to the communication management resource 141 compares the corresponding dwell times with a threshold level such as 60 minutes or other suitable value.

Using 60 minutes as a threshold level, the communication management resource determines that only the dwell time (225) of the mobile communication device 129 in the geographical region 232 is greater than the 60 minute threshold level. In such an instance, the communication management resource 141 assigns the handoff configuration information 332 to the mobile communication device 129.

Accordingly, when the mobile communication device 129 is present in the geographical region 232, the mobile communication device 129 uses the handoff configuration information 332 as a basis to handoff from the first wireless network 191 to the second wireless network 192.

Note again that the assignment of the handoff configuration information 332 to the mobile communication device 129 may be contingent upon the mobile communication device 129 or other suitable entity providing feedback indicating that the mobile communication device 129 receives good wireless service from the wireless network 192 above a threshold level while the mobile communication device 129 is in the geographical region 231.

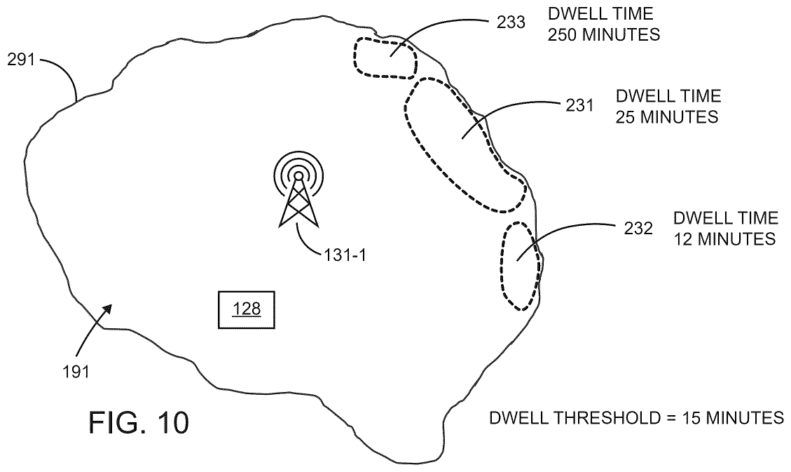

FIG. 10 is an example diagram illustrating assignment of configuration information supporting handoffs based on a dwell time of a corresponding communication device in a geographical region as discussed herein.

As previously discussed, the communication management resource 141 can be configured to produce the handoff configuration information (instructions to handoff) for each of the multiple geographical regions 231, 232, 233, etc., based upon feedback from one or more resources monitoring link performance provided by the first wireless network 191 and the second wireless network 192 to the mobile communication devices.

Each set of the handoff configuration information 331, 332, 333, etc., supports handoff from the first wireless network 191 to the second wireless network 192 during conditions in which the respective mobile communication device happens to be in a corresponding geographical region.

As previously discussed, not every communication device 121, 122, 123, 124, etc., will have difficulty communicating with the wireless base station 131-1 and corresponding wireless network 191 when they are residing at locations L1-L10 because some communication devices will work better than others. Techniques herein may include configuring only those communication devices that experience a respective inability to reliably transmit or receive communications from the wireless base station 131-1 over time.

As further shown in this example, assume that the mobile communication device 128 is newly used in the network environment 191. The communication management resource 141 can be configured to monitor feedback 171 received from the communication device 128 or other suitable entities to determine a dwell time in which the mobile communication device 128 is present in each of the geographical region 231, geographical region 232, and geographical region 233.

In this example assume that the communication management resource 141 detects that the communication device 128 is present in the geographical region 231 for 25 minutes; the communication management resource 141 detects that mobile communication device 128 is present in the geographical region 232 for 12 minutes; the communication management resource detects that the mobile communication device 128 is present in the geographical region 233 for 250 minutes.

Additionally, assume that the communication management resource 141 also receives feedback 171 indicating that the mobile communication device 128 experiences a respective poor wireless service quality with the wireless network 191 when the mobile communication device is in any of the geographical regions 231, 232, 233. In such an instance, the communication management resource 141 compares the corresponding dwell times (25 minutes, 12 minutes, and 250 minutes) with a threshold level such as 15 minutes or other suitable value.

Using 15 minutes as a threshold level, the communication management resource determines that the dwell time of 25 minutes of the mobile communication device 128 in the geographical region 231 and the dwell time 250 minutes of the mobile communication device 128 in the geographical region 233 is greater than the 15 minute threshold level. In such an instance, the communication management resource 141 assigns the handoff configuration information 331 and handoff configuration information 333 to the mobile communication device 128.

Accordingly, when the mobile communication device 128 is present in the geographical region 231, the mobile communication device 128 uses the handoff configuration information 331 as a basis to handoff from the first wireless network 191 to the second wireless network 192. When the mobile communication device 128 is present in the geographical region 233, the mobile communication device 128 uses the handoff configuration information 333 as a basis to handoff from the first wireless network 191 to the second wireless network 192.

Note again that the assignment of the handoff configuration information 332 to the mobile communication device 128 may be contingent upon the mobile communication device 128 or other suitable entity providing feedback indicating that the mobile communication device 128 receives good wireless service from the wireless network 192 above a threshold level when the mobile communication device 128 is in the geographical region 231 and geographical region 233.

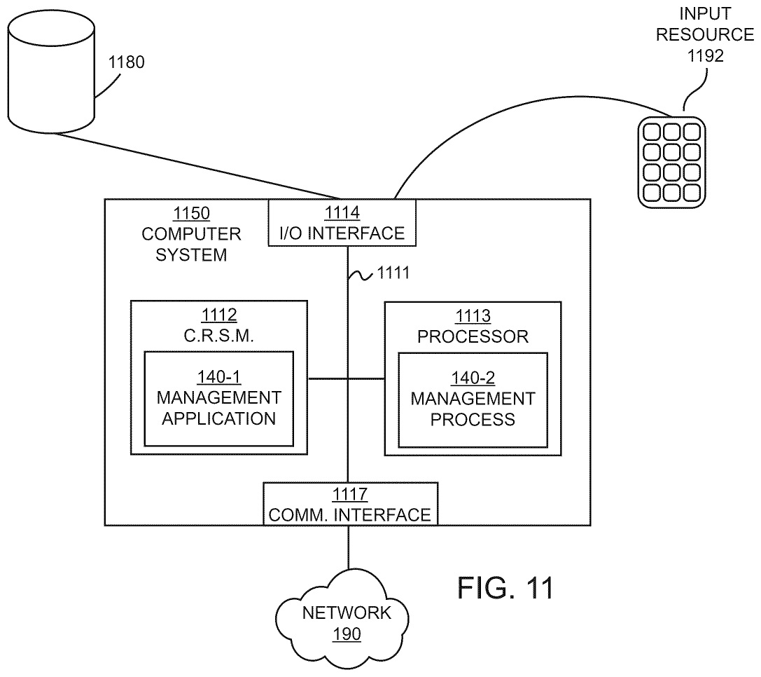

FIG. 11 is an example block diagram of a computer system for implementing any of the operations as previously discussed according to examples herein.

Note that any of the resources (such as communication management resource 141, communication management resource 140, etc.) as discussed herein can be configured to include computer processor hardware and/or corresponding executable instructions to carry out the different operations as discussed herein.

For example, as shown, computer system 1150 of the present example includes interconnect 1111 coupling computer readable storage media 1112 such as a non-transitory type of media or any suitable type of computer readable hardware storage in which digital information can be stored and or retrieved, a processor 1113 (computer processor hardware), I/O interface 1114, and a communications interface 1117.

I/O interface(s) 1114 supports connectivity to repository 1180 and input resource 1192.

Computer readable storage medium 1112 can be any hardware storage device such as memory, optical storage, hard drive, floppy disk, etc. In one example, the computer readable storage medium 1112 stores instructions and/or data.

As shown, computer readable storage media 1112 can be encoded with management application 140-1 (e.g., including instructions) in a respective wireless station to carry out any of the operations as discussed herein.

During operation of one example, processor 1113 accesses computer readable storage media 1112 via the use of interconnect 1111 in order to launch, run, execute, interpret or otherwise perform the instructions in management application 140-1 stored on computer readable storage medium 1112. Execution of the management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein.

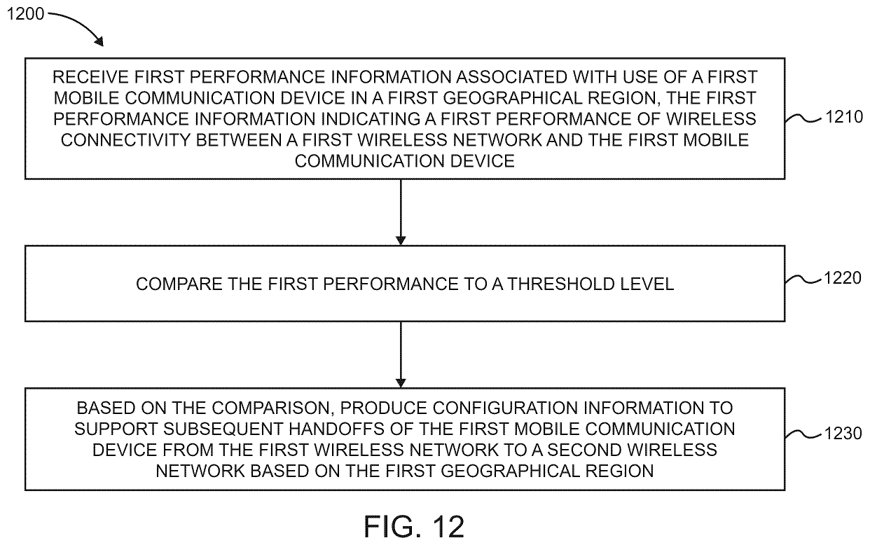

Functionality supported by the different resources will now be discussed via flowcharts in FIG. 12. Note that the steps in the flowcharts below can be executed in any suitable order.

FIG. 12 is a flowchart 1200 illustrating an example method according to examples herein. Note that there will be some overlap with respect to concepts as discussed above.

In processing operation 1210, the communication management resource 141 receives first performance information (such as based on feedback 171) associated with use of the mobile communication device 121 in a first geographical region. The first performance information indicates a first performance of wireless connectivity (such as wireless communication link 127-1) between the first mobile communication device and a first wireless network 191 such as while the mobile communication device 121 is in the first geographical region.

In processing operation 1220, the communication management resource 141 compares the first performance as indicated by the feedback 171 to a threshold level.

In processing operation 1230, based on the comparison, the communication management resource 141 produces configuration information 331 associated with the first geographical region 231. The configuration information 331 supports subsequent handoffs of the first mobile communication device 121 from the first wireless network 191 to the second wireless network 192 during conditions in which the first mobile communication device 121 is detected as residing in the geographical region 231.

Accordingly, examples herein support forcing a respective handoff of the mobile communication device 121 from the first wireless network 191 to the second wireless network 192 during conditions in which is known that the geographical region 231 does not support adequate wireless service performance to connect the mobile communication device 121 through the network 191 to the remote network 192.

Note again that techniques herein are well suited to facilitate processing of available physical infrastructure information and generation of a proposed wireless network installation plan for implementation of the new wireless network. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving first performance information associated with use of a first mobile communication device in a first geographical region, the first performance information indicating a first performance of wireless connectivity between the first mobile communication device and a first wireless network;
comparing the first performance to a threshold level; and
based on the comparing, producing configuration information associated with the first geographical region, the configuration information supporting handoffs of the first mobile communication device from the first wireless network to a second wireless network.

2. The method as in claim 1, wherein the first mobile communication device is configured with first SIM (Subscriber Identity Module) information supporting access to the first wireless network; and
wherein the first mobile communication device is configured with second SIM (Subscriber Identity Module) information supporting access to the second wireless network.

3. The method as in claim 1, wherein producing the configuration information includes:
determining a first geographical region where the first mobile communication device experiences the first performance below the threshold level, the first geographical region disposed within a region of wireless coverage associated with the first wireless network; and
producing the configuration information to support the subsequent handoffs from the first wireless network to the second wireless network in response to conditions in which the first mobile communication device resides within the first geographical region.

4. The method as in claim 3 further comprising:
implementing the configuration information to control the subsequent handoffs of the first mobile communication device from the first wireless network to the second wireless network; and
wherein the configuration information requires the first mobile communication device to reside within the geographical region for greater than a threshold amount of time prior to commencing handoff the first mobile communication device from the first wireless network to the second wireless network.

5. The method as in claim 1, wherein the first performance associated with the first performance information is based on operation of the first mobile communication device at a first location within the first geographical region, the first location being an edge of a region of wireless coverage provided by the first wireless network.

6. The method as in claim 5 further comprising:
producing the configuration information to support handoff of the first mobile communication device during conditions in which the first mobile communication device is detected as being present in the geographical region; and
communicating the configuration information to the first mobile communication device.

7. The method as in claim 1 further comprising:
transmitting a notification to the first mobile communication device, the notification instructing the first mobile communication device to monitor availability of the second wireless network while the first mobile communication device is at the first location;
in response to transmitting the notification, receiving availability information from the first mobile communication device, the availability information indicating an ability of the first mobile communication device to connect to the second wireless network; and
producing the configuration information based at least in part on the availability information.

8. The method as in claim 1 further comprising:
communicating the configuration information from the first wireless network to the first mobile communication device.

9. The method as in claim 1 further comprising:
producing the configuration information based at least in part on a dwell time of the first mobile communication device residing in the first geographical region, the first geographical region residing in a region of wireless coverage supported by the first wireless network.

10. The method as in claim 1, wherein the first performance information is associated with operation of the first mobile communication device at a first location within the first geographical region, the method further comprising:
producing the configuration information to support the subsequent handoffs during conditions in which the first mobile communication device resides in the geographical region, the geographical region being a less than all portion of a region of wireless coverage provided by the first wireless network.

11. The method as in claim 1 further comprising:
receiving second performance information indicating a second performance of conveying communications between the first mobile communication device and the second wireless network; and
producing the configuration information based on the second performance information.

12. The method as in claim 1 further comprising:
producing the configuration information in response to detecting that the first performance is below the threshold level.

13. A system comprising:
communication management hardware operative to:
receive first performance information associated with use of a first mobile communication device in a first geographical region, the first performance information indicating a first performance of wireless connectivity between a first wireless network and the first mobile communication device;
compare the first performance to a threshold level; and
based on the comparing, produce configuration information to support subsequent handoffs of the first mobile communication device from the first wireless network to a second wireless network based on the first geographical region.

14. The system as in claim 13, wherein the first mobile communication device is configured with first SIM (Subscriber Identity Module) information supporting access to the first wireless network; and
wherein the first mobile communication device is configured with second SIM (Subscriber Identity Module) information supporting access to the second wireless network.

15. The system as in claim 13, wherein the communication management hardware is further operative to:
determine a first geographical region where the first mobile communication device experiences the first performance below the threshold level, the first geographical region disposed within a region of wireless coverage associated with the first wireless network; and
produce the configuration information to support the subsequent handoffs from the first wireless network to the second wireless network in response to conditions in which the first mobile communication device resides within the first geographical region.

16. The system as in claim 15, wherein the communication management hardware is further operative to:
implement the configuration information to control the subsequent handoffs of the first mobile communication device from the first wireless network to the second wireless network; and
wherein the configuration information requires the first mobile communication device to reside within the geographical region for greater than a threshold amount of time prior to commencing handoff the first mobile communication device from the first wireless network to the second wireless network.

17. The system as in claim 13, wherein the first performance associated with the first performance information is based on operation of the first mobile communication device at a first location within the first geographical region, the first location being an edge of a region of wireless coverage provided by the first wireless network.

18. The system as in claim 17, wherein the communication management hardware is further operative to:
produce the configuration information to support handoff of the first mobile communication device during conditions in which the first mobile communication device is detected as being present in the geographical region; and
communicate the configuration information to the first mobile communication device.

19. The system as in claim 13, wherein the communication management hardware is further operative to:
transmit a notification to the first mobile communication device, the notification indicating to monitor availability of the second wireless network to the first mobile communication device while the first mobile communication device is at the first location;
in response to transmitting the notification, receive availability information from the first mobile communication device, the availability information indicating an ability of the first mobile communication device to connect to the second wireless network; and
produce the configuration information based at least in part on the availability information.

20. The system as in claim 13, wherein the communication management hardware is further operative to:
communicate the configuration information from the first wireless network to the first mobile communication device.

21. The system as in claim 13, wherein the communication management hardware is further operative to:
produce the configuration information based at least in part on a dwell time of the first mobile communication device residing in the first geographical region, the first geographical region residing in a region of wireless coverage supported by the first wireless network.

22. The system as in claim 13, wherein the first performance information is associated with operation of the first mobile communication device at a first location within the first geographical region, wherein the communication management hardware is further operative to:
produce the configuration information to support the subsequent handoffs during conditions in which the first mobile communication device resides in the geographical region, the geographical region being a less than all portion of a region of wireless coverage provided by the first wireless network.

23. The system as in claim 13, wherein the communication management hardware is further operative to:
receive second performance information indicating a second performance of conveying communications between the first mobile communication device and the second wireless network; and
produce the configuration information based on the second performance information.

24. The system as in claim 13, wherein the communication management hardware is further operative to:
produce the configuration information in response to detecting that the first performance is below the threshold level.

25. Computer-readable storage hardware having instructions stored thereon, the instructions, when carried out by computer processor hardware, cause the computer processor hardware to:
receive first performance information associated with use of a first mobile communication device in a first geographical region, the first performance information indicating a first performance of wireless connectivity between a first wireless network and the first mobile communication device;
compare the first performance to a threshold level; and
based on the comparing, produce configuration information to support subsequent handoff's of the first mobile communication device from the first wireless network to a second wireless network based on the first geographical region.
